(19) United States
(12) Patent Application Publication
(10) Pub. No.: US 2006/0282194 A1
(43) Pub. Date: Dec. 14, 2006

(54) Tape library storage bridge

(75) Inventors: Roland Schaefer, Dauchingen (DE); Christfried Welke, Radolfzell (DE)

Correspondence Address: RENNER OTTO BOISSELLE & SKLAR, LLP, 1621 EUCLID AVENUE, NINETEENTH FLOOR, CLEVELAND, OH, 44115, US

(73) Assignee: BDT AG, Rottweil (DE)

(21) Appl. No.: 11/150,839

(22) Filed: Jun. 10, 2005

(51) Int. Cl. G06F 19/00

(52) U.S. Cl. 700/245

(57) ABSTRACT

A digital data storage unit, such as tape library, has a multiplicity of storage media slots, each storage media slot for receiving a storage media, such as a tape, one or more of data transfer drives, such as tape drives, for writing data to and reading data from the storage media, a robotic device to transport the storage media between the slots or between the drives and the slots, at least one interface bridge which is connected to one or more host computers to one or more tape drives and to the robotic device, the interface bridge is performing bridging and switching operations for commands sent by the host on the basis of sub addresses, such as LUN, to send robotic mover commands to the robotic device, wherein the tape drives are addressed by main address, such as SCSI ID.

### TECHNICAL FIELD

The present invention relates to automated data storage libraries that manage the loading and unloading of portable data storage media, such as tapes, to/from media drives as well as data exchange occurring with media loaded in such drives. More particularly, the invention concerns a data storage library featuring a dual purpose data/control path between a host computer and a media drive, this path conveying control signals and data between the host and drive, and also conveying robotic mover signals from the host via a bridge to the robotic device, to drive the robotic device, which is coupled to the bridge.

### RELATED ART

One of the most popular types of mass storage systems today is the data storage “library”. Generally, a data storage library handles a great number of commonly housed portable (“removable”) data storage media, such as DLT, SDLT, LTO, AIT etc. Tapes, which are transported among various storage bins and read/write media drives by a robotic device. These libraries have become popular for many reasons. First the portable data storage media, usually a magnetic tape or an optical media, are typically quite inexpensive relative to other storage formats such as magnetic disk drives. Furthermore, libraries are easily expanded to accommodate more data, by simply adding more items of media. Additionally, most libraries can be easily updated with new equipment as it comes onto the market. For example, a new media drive may be introduced to the library to supplement or replace the existing media drives.

A number of different companies manufacture libraries today, each model displaying various different features and operating principles.

One area of focus is cost reduction and more particularly, cutting hardware costs by designing libraries that share various components. It is often difficult, however, to design components that perform multiple functions or that respond to plural master units. Frequently, this level of flexibility requires the addition of a cumbersome layer of coordinating or supervising software code, which can ultimately reduce the performance of other unrelated aspects of the library. For instance, developing software to enable multiple incompatible hosts to manage a shared inventory of media items may be prohibitively difficult or expensive in many situations.

In other cases, a shared component may need to include another port for each host, thus increasing the hardware cost of the shared component. Furthermore, some configurations experience incompatibility when multiple components share a bus or other features, resulting in reduced or lost data availability. Thus, engineers are confronted with a number of difficult challenges in their quest to consolidate components in a data storage library to reduce hardware expenses.

Normally the library and the drives are connected to host using SCSI as a communication protocol on a parallel or serial copper or fibre bus. Each component has its own SCSI address. Since the library and its robotic controller have only a very small data exchange in comparison to the drives, makes separate SCSI controller for the library very expensive.

The U.S. Pat. No. 6,434,090 B1 discloses a library, wherein the library controller is directly connected to the drive using the SCSI controller of the drive. This approach leads to limitations since the drive manufactures are using third party libraries, in which they install their drives. The library manufacturers try to keep their design independent from the drive design, to have the opportunity to equip the libraries with different drive types, such as LTO, SDLT, AIT, DAT, VX etc. To build a library based on the idea of the above-mentioned patent, a strong change of the actual drive design and firmware has to be made, which leads to a restricted application for only a few libraries.

U.S. Pat. No. 6,766,412 B2 discloses a micro bridge board, which has connectors to the host, the library and the drive. Each drive has a micro bridge board, wherein the library controller is connected to the host over the micro bridge board. The approach of this invention is to provide the optimal bridge performance to every drive, which allows replacing slow drives by faster drives, without the limitation of a central bridge. The library controller gets its control information based on the main address of the SCSI protocol. The micro bridges have no switching function which still leads to an expensive library controller.

Typically, media loaders (e.g. tape cartridge loaders) operate in accordance with a standardized command structure. Such a command structure can be found in the Small Computer System Interface-2 draft standard X3T9.2 Project 375D (ANSI X3.131-199X). In this particular industry specification, a medium changer device includes a medium transport element, at least one storage element and a data transfer element. An import/export element may also be supported. A storage element is identified as a storage slot for storing a standard medium unit, such as a disk or a tape cartridge. In order to access data on a standard medium unit, a host system issues commands to both the medium loader and to the drive.

The commands to the loader may include “move medium”; or, “exchange medium” and “read element status”. Commands directed by the host to the drive may include “test unit ready”, “inquiry”, “start-stop” and “load-unload” commands, in addition to the obvious “read/write” commands. One important characteristic about this command structure is that the logical address of the drive is supplied to the media loader as a destination, as well as to the drive itself for subsequent read or write operations from or to the selected and automatically loaded medium unit.

Individually, the data throughput rates of typical open systems tape drives range between 5 and 160 megabytes per second, and these throughput rates are increasing with new versions of tape drives. This data rate must be effectively doubled internally by a data router or bridge between the tape drives and the host system, which must simultaneously receive data from the host system and send data to the target tape drives. At a tape library system level, such throughput requirements must then be multiplied by the number of tape drives in the library to represent the aggregate data rate for the library system. This places internal throughput requirements on tape libraries at over e.g. 320 Mbytes per second.

In conventional libraries, several tape drives are connected to a high bandwidth bridge for data transfer between the tape drives and the host computers. As a result, due to high throughout demands, typical bridge devices in conventional libraries perform no data processing.

Conventional library Fibre Channel bridge implementations are either one Fibre Channel interface to several SCSI bus interfaces, or several Fibre Channel interfaces to several SCSI bus interfaces using the Fibre Channel protocol. Also, conventional libraries are limited in their protocol conversions to encapsulation/de-encapsulation, such as encapsulating SCSI protocol within Fibre Channel Protocol.

Especially when performing bridging operations, where the host is connected to the library with another bus or network than the drive, a high number of additional components have to be developed and produced to maintain functionality. This leads to higher costs and more points of failure.

### SUMMARY

The present invention alleviates the aforementioned shortcomings of conventional libraries. In one embodiment the present invention provides a data storage library for managing a plurality of portable data storage media items, such as a tape library, comprising a robotic device responsive to robotic-media-mover commands to transport the media items, such as tapes, among media locations including media storage bins or slots and one or more media drives including at least one robotic interface. This interface is very often a slow serial connection like RS 232, RS 422, RS 485, I²C, TTL or USB, other slow and cheap connections are possible, since the data volume is, in comparison to the data volume which has to be sent to the library, small. Furthermore the library comprises one or more media drives, configured to receive removable media items, such as tapes (DLT, AIT, SDLT, LTO etc.), and exchange data therewith. Each said drive includes at least one drive interface to receive thereon read/write data commands directing an exchange of data with a media item received by the media drive. This interface is very often parallel or serial SCSI or Fibre Channel (copper or fibre optic based), other interfaces are also possible like Serial ATA (SATA), ATA, firewire, USB, iSCSI.

A fibre channel to SCSI bridge allows to use cheaper drives. Further the serial connection is a cheap solution.

A further component of the invention is a bridge controller comprising one or more host interfaces to receive read/write data commands and robotic-media-mover commands from a host and comprising one or more drive interfaces connected to one or more of the media drives to forward the read/write data commands to the media drive. Bridging is always necessary when different types of interfaces are used on the host side and the drive side. As mentioned above, the bridge only performs a packing and unpacking of information and forwards them.

The bridge controller also comprises a robotic interface connected to the robotic device, to forward the robotic-media-mover commands to the robotic device. All the commands are tagged with a main address, such as the SCSI ID address, wherein the read/write data commands comprise a main address to address the target media drive, and the robotic-media-mover commands comprise the main address and a sub address, such as the SCSI LUN. Also other protocols with main and sub addresses can be used.

The bridge controller is configured to detect the robotic-media-mover commands based on the sub address to forward the robotic-media-commands over the robotic interface to the robotic device and vice versa. The read/write data commands are forwarded over the drive interface to the media drive, as a standard bridge would do. Using this design, additional expensive library controllers, such as a SCSI or FC controller for the library, can be saved. The bridge controller performs two bridging operations (host to drive, host to robotic controller) and further a switching operation concerning commands tagged with a sub address.

In another embodiment having a plurality of drive or host interfaces the bridge also performs switching operations on the basis of the main address to forward the messages to the right drive or host.

In another embodiment the bridging and switching operations are performed by a remote management unit (RMU) that is often connected through an Ethernet cable to the IP network. Other networks might also be supported. The RMU provides status information and executes some operation commands, which are normally performed just in front of the library, but the RMU allows the execution from a remote place. The RMU is not integrated into operations and commands sent by the standard backup software such as Veritas Backup exec etc. since the data exchange is based on http or https. The invention modifies the function of the RMU by connecting it to the robotic device and performing bridging operations based on an IP-Protocol such as iSCSI, to connect the robotic device to the host.

Thus, in one embodiment the invention may be implemented to provide an apparatus comprising a data storage library. In another embodiment the invention may be implemented to provide a method to operate a data storage library. In still another embodiment, the invention may be implemented to provide a signal bearing medium tangibly embodying a program of machine-readable instructions executable by a digital data processing apparatus to perform method steps to operate a data storage library.

The invention affords its users with a number of distinct advantages. Significantly, the invention may be implemented to save hardware costs, since no additional controllers are necessary for the robotic controller. Furthermore, the invention avoids complicated host software that would otherwise be required to operate shared components. In addition, reducing the number of components leads to a smaller number of points of failure. Also, the library of the invention is beneficial because it enables a heterogeneous mix of otherwise incompatible hosts to share a single robotic device and a common inventory of media items. The invention also provides a number of other advantages and benefits, which should be apparent from the following description of the invention.

### BRIEF DESCRIPTION OF THE DRAWINGS

For a more complete understanding of the present invention, reference is established to the following description made in connection with accompanying drawings in which:

FIG. 1 shows a bridge controller connected via iSCSI or Fibre Channel to the host, wherein the drive is connected via parallel SCSI to the SCSI Drive, the robotic controller is connected via a serial interface to the bridge controller using USB, RS232, RS422, RS 485, I²C, TTL or the like, and the drive is also connected via a serial connection to the robotic controller;

FIG. 2 shows an alternative embodiment, wherein the drive is connected to the bridge controller via serial attached SCSI (SAS), USB or Fire Wire e.g.;

FIG. 3 shows an alternative embodiment, wherein the multiple drives are connected to the bridge controller via serial ATA e.g.;

FIG. 4 shows an alternative embodiment, wherein the bridge controller and the library/robotic controller are located on one chip or one board, the slower and more cost effective connection between the components may be maintained;

FIG. 5 shows an alternative embodiment with multiple bridge controllers, wherein each bridge controls multiple drives, which are connected via the parallel SCSI bus;

FIG. 6 shows an alternative embodiment, wherein the bridge uses the same network interface as the Remote Management Unit (RMU) of the library, so the robotic controller receives its command over an IP-Network from the host, the drives are connected to the host via SCSI, Fibre Channel or SAS etc.;

FIG. 7 shows an alternative embodiment of FIG. 6, wherein the bridge uses the same network interface as the Remote Management Unit (RMU) of the library, so the robotic controller receives its command over an IP-Network from the host, the drives are connected to the host via a second bridge controller that converts Fibre Channel to parallel SCSI etc.;

FIG. 8 shows an alternative embodiment of FIG. 6, wherein the bridge uses the network interface as the Remote Management Unit (RMU) of the library, so the robotic controller receives its command over an IP-Network from the host, the drives are connected to the host via a second bridge controller that converts Internet SCSI (iSCSI) to parallel SCSI, so the host is only connected to the IP-Network etc.;

FIG. 9 shows a flow diagram, wherein a switching is performed on SCSI sub address basis etc.;

FIG. 10 shows an alternative flow diagram, wherein a switching is also performed on SCSI ID basis in a multiple drives and bus system.

FIG. 11 shows a SAS to SAS/SATA bridge using a cost sensitive design, wherein the robotic/library controller is responsible for the bridging operations.

### DETAILED DESCRIPTION

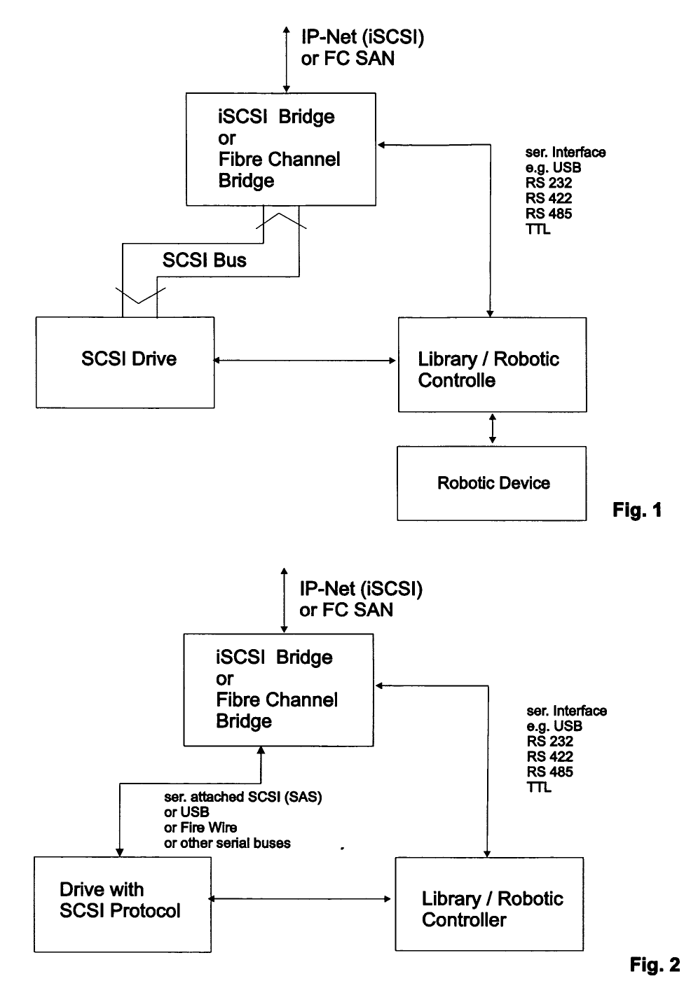

FIG. 1 shows the bridge controller connected via iSCSI or Fibre Channel to the host. The physical connection can be optical or copper. The drive is connected with parallel SCSI to the bridge controller. Depending on how the host is connected to the bridge controller it performs an iSCSI to SCSI bridging or FC to SCSI bridging. Furthermore the bridge controller provides a relative slow connection, such as USB, RS232, RS422, RS485, I²C, TTL etc., to the robotic controller of the library. Other cost effective connections are also possible. The bridge controller performs a switching operation on the basis of a sub address to send robotic media mover commands to the robotic controller and bridge the other commands (e.g. read/write commands) to the drive. Using the SCSI protocol the main address is the SCSI ID and the sub address is the LUN. The bridge provides switching operation on the basis of the LUN and also performs bridging operations, from the host connection (iSCSI or FC) to the parallel SCSI and from the host connection (iSCSI or FC) to the serial interface e.g. USB, RS 232, RS422, RS485, I²C or TTL. To perform these operations a SCSI Controller can be integrated into the bridge controller. Since the robotic media mover commands are directed to move a tape from one slot to another or from a slot to the drive or from the drive to a slot, they are performed not very often and don't require a lot of data exchange, a relative slow connection is sufficient to control the robotic controller. The use of a LUN or sub address has the advantage that a main address in the restricted address space is saved and the LUN is easy to unmask during the data exchange.

Further the SCSI Drive is connected to the robotic controller to exchange status information and control information. A possible command could be loading and unloading of a tape. The robotic controller is connected to a robot (not shown) that transports tapes from one slot or bin (not shown) to another or to the drive.

The robotic device includes a processing unit to interpret the SCSI commands forwarded from the bridge controller. These commands are interpreted by a software interpreter that can be modified by a firmware update.

In another embodiment the bridge controllers has further a memory to store information about the status of the robotic device or the inventory of the slots. This speeds up the processing time, since the commands requesting these information can be answered by the bridge controller itself. The necessary information is transferred from the library controller to the bridge controller periodically from time to time or after a defined event. The library controller can combine the robotic controller and the library interface controller in a possible embodiment.

FIG. 2 shows a configuration with a serial attached drive. The drive has a serial attached SCSI (SAS), USB or Fire Wire interface and the bridge controller is performing bridging operations from iSCSI or FC to SAS, USB or Fire Wire. The drive itself supports the SCSI protocol. Other combinations are also possible. The bridging operations to the robotic controller are based on sub address switching.

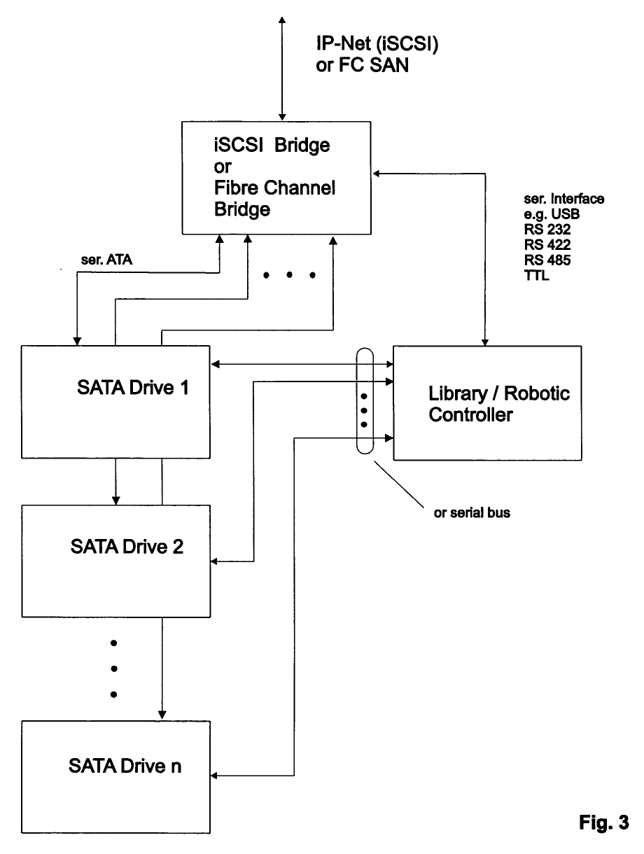

FIG. 3 shows a configuration with multiple serial ATA drives. The drives have a SATA interface and the bridge controller is performing bridging operations from iSCSI or FC to SATA. The drive itself supports the SATA protocol. Other combinations are also possible. The bridging operations to the robotic controller are based on sub address switching. SATA or SAS are point to point protocols.

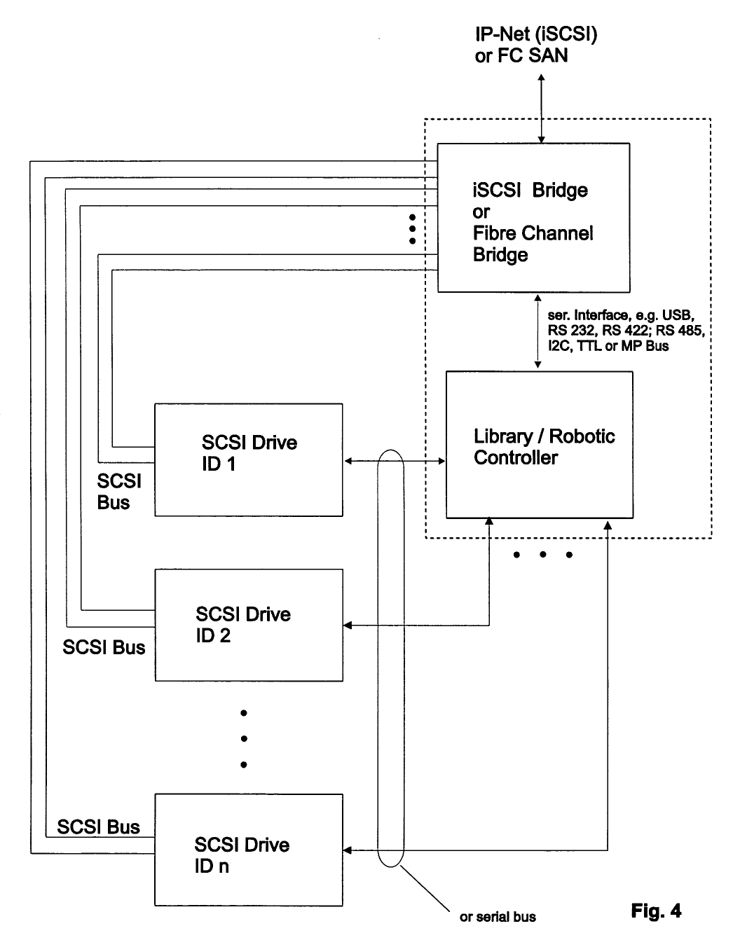

FIG. 4 shows another alternative embodiment, wherein the bridge controller and the library/robotic controller are located on one chip or one board. The slower and more cost effective connection between the components as described above can still be used. Further the multiple drives are connected to the library/robotic controller via a serial bus or a loop.

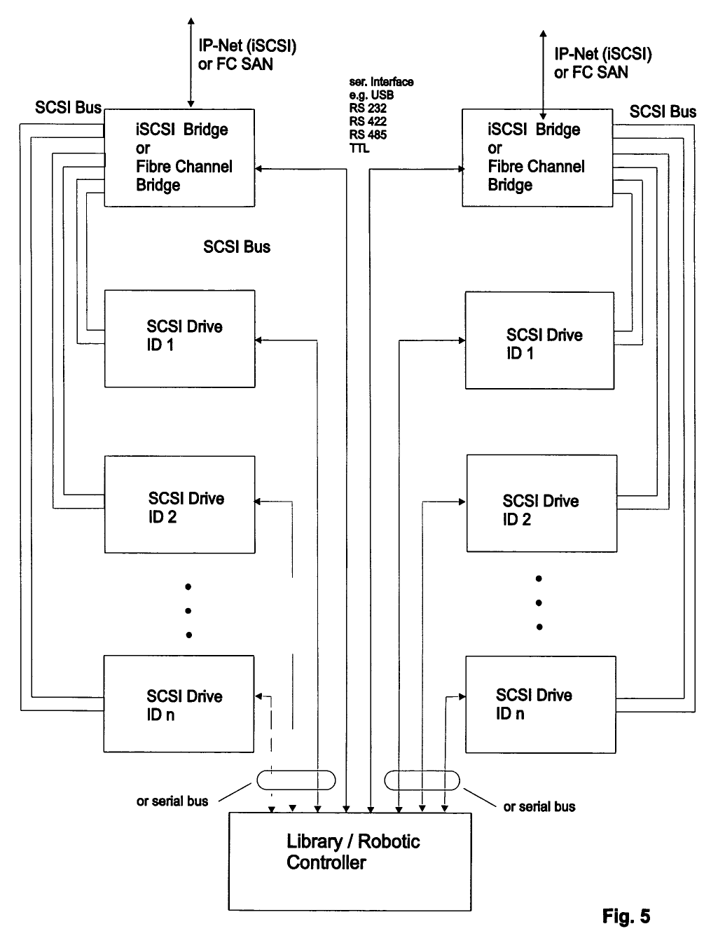

FIG. 5 shows a configuration with two bridge controllers each has a plurality of connectors to SCSI drives with different SCSI IDs. Each drive is connected to the robotic controller with a standard serial connection and each bridge controller is connected to the robotic controller. The bridging operations are identical to the embodiments described above.

In a preferred embodiment the bridging controller is a separate board with cable connectors, for the host(s), drive(s) and robotic controller. In a possible embodiment the board is ready to use different types and numbers of host interfaces and drive interfaces to optimize the layout. Depending on the library a plurality of host interfaces or drive interfaces can be activated by the firmware or by other switches on the board. Further the drives may be connected to the robotic controller via a serial bus.

Nowadays a lot of the libraries are equipped with a remote management unit (RMU). This RMU is connected to the IP network using a RMU interface to provide information about the unit. Very often the network connection is established by the http(s) protocol. The RMU comprises a web server that allows a remote management of the unit. The system administrator has not to go to the front panel of the library to execute operations, when using the RMU. The RMU is not integrated into the standard backup software that controls the library, such as Veritas Backup Exec, CA ARCserve etc. since iSCSI is becoming more and more important, the software supports iSCSI, so the RMU can be used as bridge.

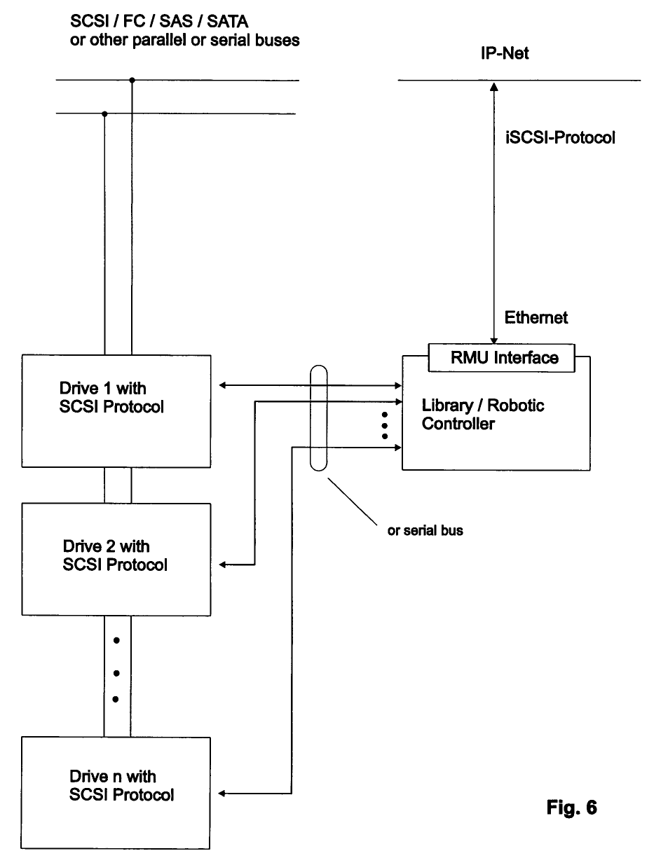

FIG. 6 shows a possible embodiment of an iSCSI controller or bridge. The RMU is modified to work also as an iSCSI bridge for the robotic controller. In a preferred embodiment, the processor handling the RMU commands also processes the robotic mover commands. This can be done by different programs running on the same processor, wherein the processor is connected to a network interface of the IP network. In an alternative embodiment there are two controllers, one for the RMU and one as iSCSI Bridge. In a further embodiment the whole Library controller, comprising the robotic controller can be located on the RMU board, and can be implemented on one processor. The host that controls the library is connected to the IP network and also to the SCSI, FC or SAS bus of the drives. The robotic media mover commands are sent over the IP network. This can be implemented by special drivers on the host or by the backup software. The RMU can distinguish the different commands for the RMU or the robotic controller by different port numbers when using one IP address or by different IP addresses if the RMU is multi homed.

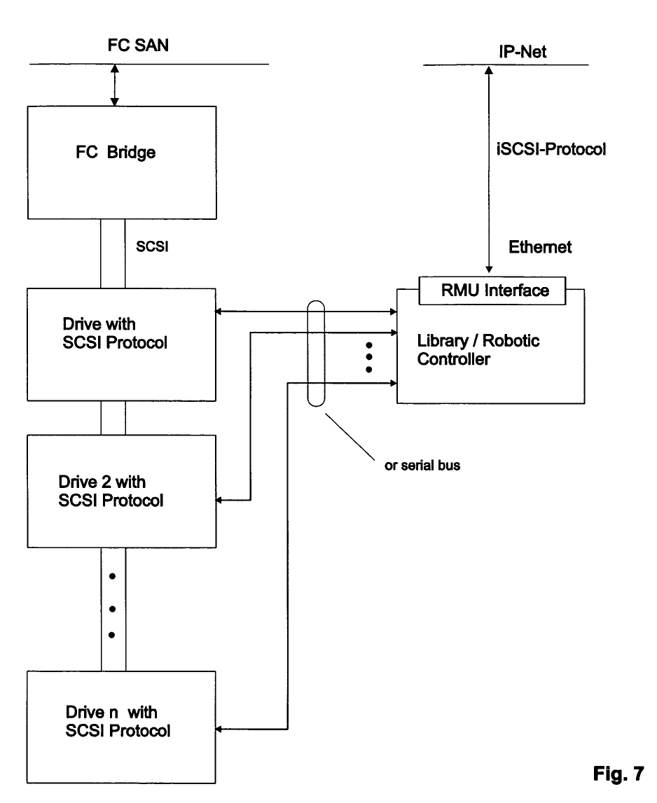

FIG. 7 shows a possible embodiment with an additional FC bridge between the host and the SCSI drive.

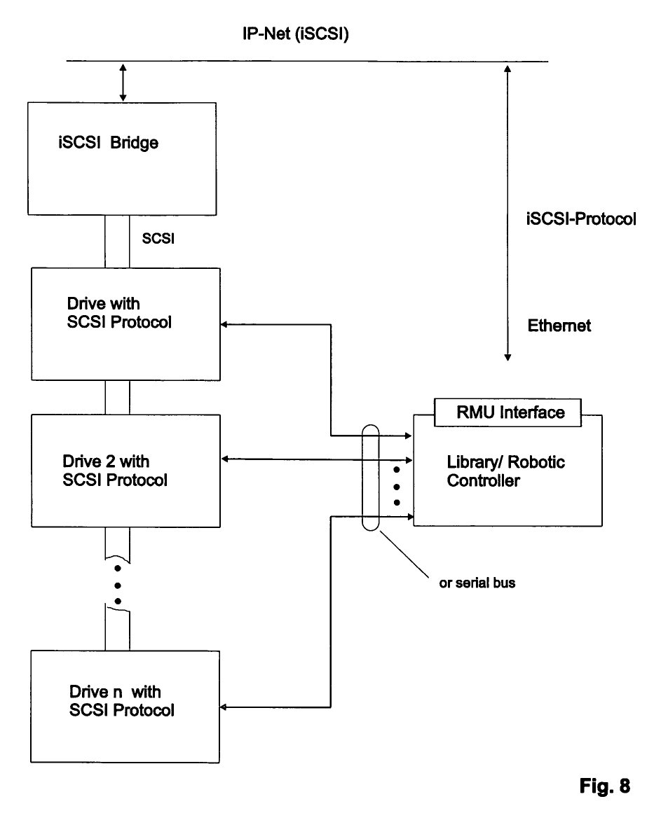

FIG. 8 shows a possible embodiment with an additional iSCSI bridge between the drive and the IP network. In this case the host is connected to the drive as well as to the robotic controller over the IP network.

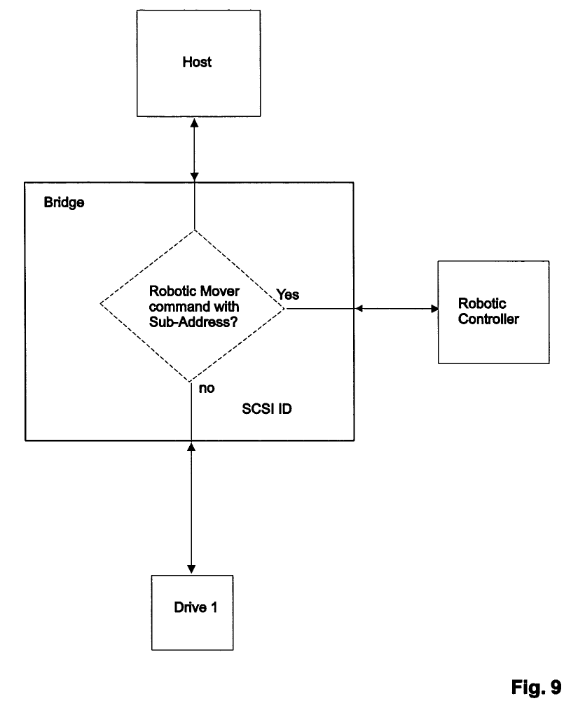

FIG. 9 shows a flow chart of the bridge controller that analyses the commands received at the host interface. Based on the sub address robotic media mover commands are detected, which are forwarded to the robotic interface to perform a bridge operation. If no robotic media mover commands are detected the commands are transferred to the drive interface bridge. The bridge operation can also be performed before the detection.

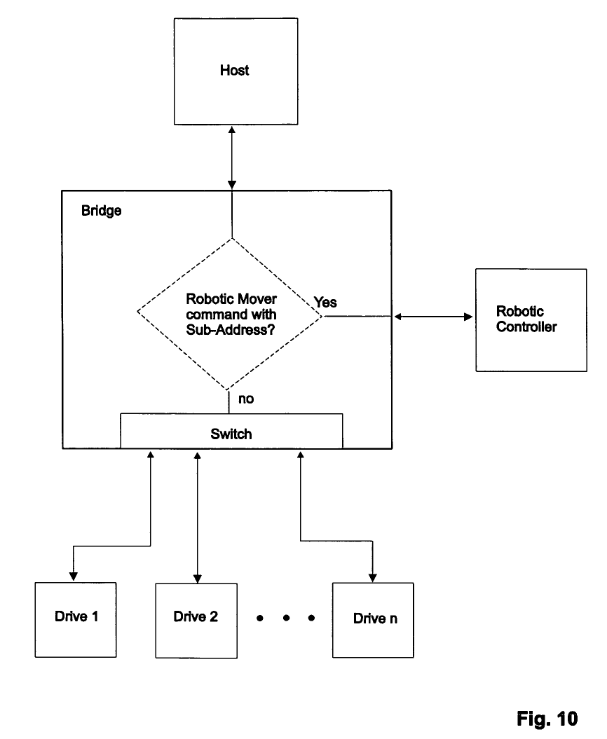

FIG. 10 shows a flow chart of the bridge controller that also performs switching operation if multiple drives are connected to multiple drive interfaces. Using the SCSI protocol the switching is performed based on the SCSI ID.

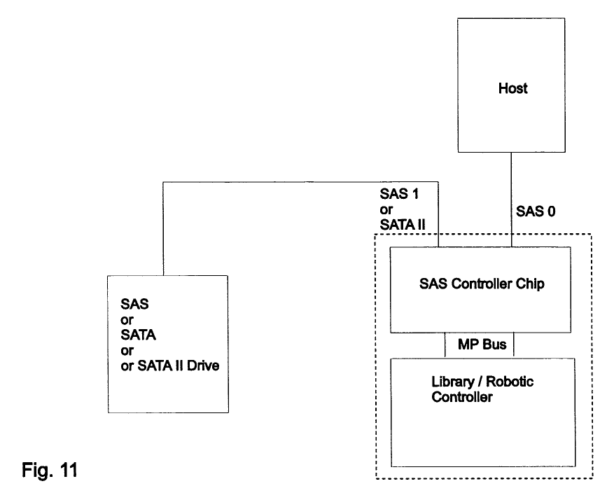

FIG. 11 shows an alternative embodiment which might be used for point to point connections like SAS/SATA. To avoid an expensive port-multiplexer or expander a SAS interface controller like a two port chip from QLogic® might be used in combination with a powerful library controller. The library controller might be an ARM processor which is connected by a MP bus interface to the interface controller. One SAS port of the interface controller is connected to the host the other SAS port is connected to the drive via SAS or SATA, depending on the drive. The interface controller is controlled by the library controller performing the bridging operations and the switching operations based on the sub address, as mentioned above. The bridging can be from SAS to SAS or SAS to SATA based on the STP protocol. Furthermore the library controller handles the media mover commands, which are sent to the robotic device. All these three functions are preferably implemented by a software running on the processor. The approach has the advantage, that different types of drives can be used (SAS, SATA) and no multiplexer or expander has to be used.

It should be obvious for the man skilled in the art, that all described communications in this document can also be bidirectional.

### Other Embodiments

While there have been shown what are presently considered to be preferred embodiments of the invention, it will be apparent to those skilled in the art that various changes and modifications can be made herein without departing from the scope of the invention as defined by the appended claims.

What is claimed is:

1. A data storage library for managing a plurality of portable data storage media items, comprising:
a robotic device responsive to robotic-media-mover commands to transport the media items among media locations including media storage bins and one or more media drives including at least one robotic interface; and
one or more media drives, configured to receive removable media items and exchange data therewith, each said drive including at least one drive interface to receive thereon read/write data commands directing an exchange of data with a media item received by the media drive,
at least one bridge controller
with one or more host interfaces to receive read/write data commands and robotic-media-mover commands from a host,
with one or more drive interfaces connected to one or more of the media drives to forward the read/write data commands to the media drive,
with a robotic interface connected to the robotic device, to forward the robotic-media-mover commands to the robotic device,
wherein the read/write data commands comprise a main address to address the target media drive, and the robotic-media-mover commands comprise the main address and a sub address,
wherein the bridge controller detects the robotic-media-mover commands based on the sub address to forward the robotic-media-commands over the robotic interface to the robotic device and
wherein the read/write data commands are forwarded over the drive interface to the media drive.

2. The data storage library of claim 1, wherein the bridging interface has a switch function on the basis of the main address and also a switch function on the basis of the sub address.

3. The data storage library of claim 1, wherein read/write data commands and the robotic-media-mover commands are transferred based on the SCSI protocol, the main address is the SCSI ID and the sub address is the LUN.

4. The data storage library of claim 3, wherein the bridge controller detects multiple SCSI ID LUN combinations when controlling multiple drives to forward the robotic-media-mover commands to the robotic device.

5. The data storage library of claim 3, wherein the bridge controller comprises a SCSI controller that handles LUN addressing for forwarding the robotic-media-mover commands to the robotic device.

6. The data storage library of claim 1, wherein the bridge controllers have a memory to store information about status of the robotic device or the inventory of the media locations.

7. The data storage library of claim 1, wherein the robotic device is connected with one or more media drives, to exchange status information or commands.

8. The data storage library of claim 1, wherein the robotic-media-mover commands include signals specifying movement of a particular media item from a source location to a destination location, each of said source and destination locations comprises one of the following: a storage bin, one of the media drives.

9. The data storage library of claim 1, wherein the read/write data commands include signals specifying sending data to be stored from the host on a storage media item by a media drive, commands including signals specifying sending data to be restored from a storage media item to the host by a media drive.

10. The data storage library of claim 1, the drives comprising magnetic tape drives, harddisk drives, removable disk drives or optical disk drives, and the media items comprising magnetic tapes, removable disks, harddisk drives or optical disks.

11. The data storage library of claim 1, wherein the host interface and the drive interface are of different types and the bridge controller converts the information between the different types of interfaces one of the following: SCSI to SAS, SCSI to Fibre Channel, SCSI to ATA, SCSI to SATA, SCSI to Firwire, SCSI to USB, SCSI to iSCSI, SAS to Fibre Channel, SAS to SATA, SAS to ATA, SAS to Firewire, SAS to USB, SAS to iSCSI, Fibre Channel to Serial SATA, Fibre Channel to ATA, Fibre Channel to Firewire, Fibre Channel to USB, Fibre Channel to iSCSI, SATA to ATA, SATA to Firewire, SATA to USB, SATA to iSCSI, ATA to Firewire, ATA to USB, ATA to iSCSI, Firewire to USB, Firewire to iSCSI, USB to iSCSI.

12. The data storage library of claim 1, wherein the host interface and the robotic interface are of different types and the bridge controller converts the information between the different types, comprising one of the following: SCSI to USB, SCSI to RS 232, SCSI to RS 422, SCSI to RS 485, SCSI to TTL SCSI to I²C, Serial attached SCSI (SAS) to USB, SAS to RS 232, SAS to RS 422, SAS to RS 485, SAS to TTL, SAS to I²C, Fibre Channel to RS 232, Fibre Channel TO RS 422, Fibre Channel to RS 485, Fibre Channel to TTL, Fibre Channel to I²C, Serial ATA Interface (SATA) to USB, SATA to RS 232, SATA to RS 422, SATA to RS 485, SATA to TTL, SATA to I²C, ATA to RS 232, ATA to RS 422, ATA to RS 485, ATA to TTL, ATA to I²C, Firewire to USB, Firewire to RS 232, Firewire to RS 422, Firewire to RS 485, Firewire to TTL, Firewire to I²C, iSCSI to USB, iSCSI to RS 232, iSCSI to RS 422, iSCSI to RS 485, iSCSI to TTL, iSCSI to I²C

13. The data storage library of claim 3, wherein the robotic device includes a processing unit to interpret the SCSI commands received from the bridge controller.

14. The data storage library of claim 1, wherein the bridge controller is a separate board with cable connectors.

15. The data storage library of claim 14, wherein the layout of the board is ready to use different types and numbers of host interfaces and drive interfaces.

16. The data storage library of claim 14, wherein a plurality of host interfaces is located on the board.

17. The data storage library of claim 14, wherein a plurality of drive interfaces is located on the board.

18. The data storage library of claim 14, wherein the robotic controller is located on the board.

19. A method for controlling a digital data storage library comprising:
a robotic device responsive to robotic-media-mover commands to transport media items among media locations including media storage bins and one or more media drives including at least one robotic interface; and
one or more media drives, configured to receive removable media items and exchange data therewith, each said drive including at least one drive interface to receive thereon read/write data commands directing an exchange of data with the media item received by the media drive,
at least one bridge controller with one or more host interfaces, connected to a host and with one or more drive interfaces connected to one or more of the media drives,
with a robotic interface connected the robotic device, comprising the following steps:
the bridge controller receives read/write data commands at the host interface from the host with a main address directed to the media drive, performs a bridging operation to forward the read/write data commands over the drive interface to the media drive,
the bridge controller receives robotic-media-mover commands from the host at the host interface with a main address and a sub address, based on the sub address the bridge controller switches the robotic-media-mover commands to the robotic interface performing a bridge operation.

20. The method of claim 19, wherein the bridge controller also switches read/write data commands on basis of the main address when a plurality of drives is connected to the drive interfaces of the bridge controller.

21. The method of claim 19, wherein read/write data commands and the robotic-media-mover commands are transferred based on the SCSI protocol, the main address is the SCSI ID and the sub address is the LUN.

22. The method of claim 19, wherein the bridge controller detects multiple SCSI IDs with LUN address combination, when multiple drives are connected to the bridge controller, to switch the robotic-media-mover commands to the robotic device.

23. The method of claim 19, wherein commands requesting the status of the robotic device or the inventory of the media locations are not forwarded to the robotic controller, they are handled by the bridge controller directly.

24. The method of claim 19, wherein the robotic exchanges information with one or more media drives directly, to exchange status information or commands.

25. The method of claim 19, wherein the read/write data commands include signals specifying sending data to be stored from the host on a storage media item by a media drive, commands including signals specifying sending data to be restored from a storage media item to the host by a media drive.

26. The method of claim 19, wherein the host interface and the drive interface are of different types and the bridge controller bridges the information between the different types of interfaces comprising one of the following: SCSI to SAS, SCSI to Fibre Channel, SCSI to ATA, SCSI to SATA, SCSI to Firewire, SCSI to USB, SCSI to iSCSI, SAS to Fibre Channel, SAS to SATA, SAS to Firewire, SAS to USB, SAS to iSCSI, Fibre Channel to SATA, Fibre Channel to ATA, Fibre Channel to Firewire, Fibre Channel to USB, Fibre Channel to iSCSI, SATA to ATA, SATA to ATA, SATA to Firewire, SATA to USB, SATA to iSCSI, ATA to Firewire, ATA to USB, ATA to iSCSI, Firewire to USB, Firewire to iSCSI, USB to iSCSI.

27. The method of claim 19, wherein the host interface and the robotic interface are of different types and the bridge controller bridges the information between the different types, comprising one of the following: SCSI to USB, SCSI to RS 232, RS 422, RS 485, SCSI to TTL, Serial attached SCSI (SAS) to USB, SAS to RS 232, SAS to RS 422, SAS to RS 485, SAS to TTL, Fibre Channel to RS 232, Fibre Channel TO RS 422, Fibre Channel to RS 485, Fibre Channel to TTL, Serial ATA Interface (SATA) to USB, SATA to RS 232, SATA to RS 422, SATA to RS 485, SATA to TTL, ATA interface to RS 232, ATA to RS 422, ATA to RS 485, ATA to TTL, Firewire interface to USB, Firewire to RS 232, Firewire to RS 422, Firewire to RS 485, Firewire to TTL, iSCSI to USB, iSCSI to RS 232, iSCSI to RS 422, iSCSI to RS 485, iSCSI to TTL.

28. A data storage library for managing a plurality of portable data storage media items, comprising:
a robotic device responsive to robotic-media-mover commands to transport the media items among media locations including media storage bins and one or more media drives including at least one robotic interface; and
one or more media drives, configured to receive removable media items and exchange data therewith, each said drive including at least one drive interface to receive thereon read/write data commands directing an exchange of data with a media item received by the media drive from a host,
a remote management unit, connected to a IP network with a network interface and connected to the robotic device with robotic interface,
wherein the remote management network interface receives remote management commands sent over the IP network and receives also robotic-media-mover commands sent over the IPnetwork.

29. The data storage library of claim 28, wherein the network interface is connected to a bridge to bridge robotic-media-mover commands, sent by a host being connected to the package based network, to the robotic device and to the remote management unit.

30. The data storage library of claim 28, wherein a circuit processing commands for the remote management unit has also the function of an iSCSI bridge and is connected to the network interface.

31. The data storage library of claim 28, wherein the remote management unit displays a web-front-end to handle the remote management commands based on http.

32. The data storage library of claim 28, wherein the remote management commands and the robotic-media-mover commands are addressed to the same IP address using different ports.

33. The data storage library of claim 28, wherein the network interface of the remote management unit is multi homed handling multiple IP addresses, using one IP address for the remote management commands and using the second IP address for the robotic-media-mover commands.

34. The data storage library of claim 28, wherein the host is connected to the robotic controller only via the package based network over the remote management connector.

35. The data storage library of claim 28, wherein the drive interface is one of the following: SCSI, Serial attached SCSI (SAS), Fibre Channel, Serial ATA (SATA), ATA, Firewire, USB, iSCSI, and the host is connected directly or over a bridge to the drive.

36. The data storage library of claim 28, wherein the drive is connected to the RMU library controller of the remote management unit, to exchange commands and status information.

37. A method for controlling a digital data storage library comprising
a robotic device responsive to robotic-media-mover commands to transport media items among media locations including media storage bins and one or more media drives including at least one robotic interface; and
one or more media drives, configured to receive removable media items and exchange data therewith, each said drive including at least one drive interface to receive thereon read/write data commands directing an exchange of data with the media item received by the media drive,
a remote management unit, connected to a package based network with a network interface and connected to the robotic interface with a robotic device connector,
comprising the following steps:
receiving and analysing a command sent to the network interface
if the command is a robotic-media-mover command forwarding the command to the robotic interface,
if the command is a remote management command processing the remote management command.

38. The method of claim 37, wherein the RMU performs iSCSI bridge functions.

39. The method of claim 37, wherein commands are transmitted over an IP network.

40. The method of claim 39, wherein the remote management unit bridges the robotic-media-mover commands that are sent using the iSCSI protocol to the robotic interface.

41. The method of claim 39, wherein the remote management unit recognizes the remote management commands based on http or https requests.

42. The method of claim 39, wherein the remote management commands and the robotic media mover commands are recognized based on the different port for the remote management commands and the robotic-media-mover commands.

43. The method of claim 39, wherein, if the network interface of the remote management unit is multi homed handling multiple IP addresses, the remote management commands and the robotic-media-mover commands are recognized based on the different IP addresses for the remote management commands and for the robotic-media-mover commands.

44. A data storage library for managing a plurality of portable data storage media items, comprising:
a robotic device responsive to robotic-media-mover commands to transport the media items among media locations including media storage bins and one or more media drives including at least one library controller; and
one or more media drives, configured to receive removable media items and exchange data therewith, each said drive including at least one point to point drive interface to receive thereon read/write data commands directing an exchange of data with a media item received by the media drive,
at least one interface controller
with at least one host point to point interface to receive read/write data commands and robotic-media-mover commands from a host,
with at least one point to point interface connected to one of the media drives to forward the read/write data commands to the media drive,
with the library controller connected to the interface controller performing bridging operations,
wherein the read/write data commands comprise a main address to address the target media drive, and the robotic-media-mover commands comprise the main address and a sub address,
wherein the library controller controls the interface controller to detect the robotic-media-mover commands based on the sub address, to control the robotic device,
wherein the read/write data commands are forwarded over the drive interface to the media drive.

45. The data storage library of claim 44, wherein the point to point interface to the host is SAS and SAS/SATA to the drive.

46. The data storage library of claim 45, wherein the interface controller is an intelligent SAS Chip having at least two SAS ports and one microprocessor interface connected to the library controller, performing the bridging operations.
